(19) United States
(12) Patent Application Publication
(10) Pub. No.: US 2008/0298798 A1
(43) Pub. Date: Dec. 4, 2008

(54) Camera flash brackets

(76) Inventor: Andy You Lien Lin, Sanchong City (TW)

Correspondence Address: BIRCH STEWART KOLASCH & BIRCH, PO BOX 747, FALLS CHURCH, VA, 22040-0747, US

(21) Appl. No.: 11/806,632

(22) Filed: Jun. 1, 2007

(51) Int. Cl. G03B 11/00

(52) U.S. Cl. 396/544

(57) ABSTRACT

The invention relates to a camera flash brackets that is provided on the outside of a camera lens, comprising a ring portion and an assembling portion provided on the surface of the ring portion for being assembled with a photoflash; the ring portion has more than one steel balls mounted thereon, thereby the rotation of the steel balls and the positioning holes enable the photoflash to be adjusted and positioned.

### BACKGROUND OF THE INVENTION

I. Field of the Invention

The present invention relates to a camera flash brackets that enables a photoflash assembled thereon to be positioned and adjusted, especially to a stand that enables a photoflash to be quickly adjusted and positioned corresponding to photo taken angles of a camera.

II. Description of the Prior Art

With reference to FIG. 1, a conventional camera flash brackets 10 mainly comprises a linked stand 101 and an assembling portion 102, wherein the linked stand 101 is formed as a staple-like shape and the assembling portion 102 is provided on the top of the linked stand 101. The linked stand 101 has both lateral sides thereof respectively provided on the surface of a camera and the camera lens; a photoflash is provided on the surface of the assembling portion 102, thereby enabling a user to manually sway the photoflash thereon to both sides. The linked stand 101 comprises a plurality of legs, which can be extensively and jointly moved, enabling the photoflash on top of the assembling portion 102 above the linked stand 101 to jointly change the angle. However, said conventional linked stand 101 is unable to jointly change the photoflash angles smoothly, so that a user has to spend time in adjusting photoflash positioned angles, so as to miss the special moment for shooting. Therefore, such conventional camera flash brackets 10 is required to be improved.

### SUMMARY OF THE INVENTION

In view of the foregoing assembly and use drawbacks of said conventional structure, an innovative “camera flash brackets” is therefore disclosed hereafter. The main objective of the present invention is to provide a camera flash brackets that enables a photoflash to be quickly adjusted and positioned.

Accordingly, the camera flash brackets of the invention comprises a ring portion, a plate, an assembling portion and at least one steel ball. The ring portion comprises a slip ring, a first fastening ring and a second fastening ring, wherein the first fastening ring forms a plurality of grooves thereon with each steel ball set on each of the grooves, the slip ring forms a plurality of positioning holes thereon for positioning said steel balls. The ring portion has a hollow portion set in the center thereof, the assembling portion set on top thereof and a connection portion set on the other side thereof for being assembled with the plate; said steel balls are provided in the ring portion, each two steel balls form the same interval in between; in addition, a photoflash is mounted on the assembling portion of the camera flash brackets, the bottom of a camera is positioned on the plate surface of the camera flash brackets and the camera lens is set piercing through the hollow portion of the ring portion, therefore, when a user wants to adjust the photoflash positioned angles, s/he only needs to directly revolve the slip ring of the ring portion, thereby enabling the steel balls to shift to positioning holes on the slip ring for fastening together, so as to position the photoflash quickly without spending time in adjusting the photoflash.

### BRIEF DESCRIPTION OF THE DRAWINGS

FIG. 1 is a front view showing a conventional camera flash brackets;

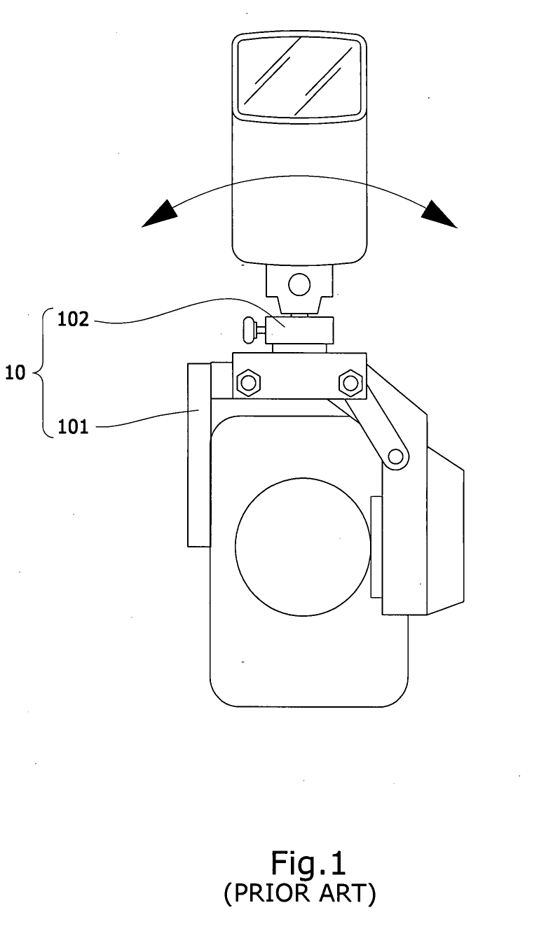

FIG. 2 is a cross-sectional view showing the frontage of the camera flash brackets of the invention;

FIG. 3 is a cross-sectional view showing the lateral side of the camera flash brackets of the invention;

FIG. 4 is perspective view showing an embodiment of the camera flash brackets in accordance with the invention;

FIG. 5 is a perspective view showing a preferred embodiment (1) of the camera flash brackets of the invention; and

FIG. 6 is a perspective view showing another preferred embodiment (2) of the camera flash brackets of the invention.

### DESCRIPTION OF THE PREFERRED EMBODIMENT

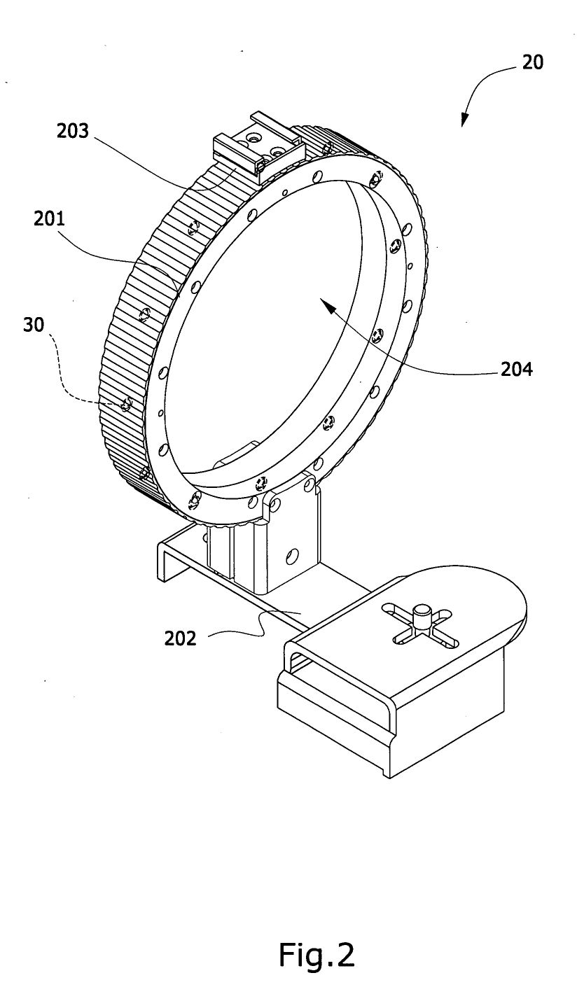

Further aspects, objects, and desirable features of the invention will be better understood from the detailed description and drawings that follow in which various embodiments of the disclosed invention are illustrated by way of examples. With reference to FIG. 2, the “camera flash brackets” of the invention mainly comprises a ring portion 201, a plate 202, an assembling portion 203 and more than one and above steel balls 30. The assembling portion 203 is provided on top of the ring portion 201, the plate 202 is provided on the other side of the ring portion 201 and the plurality of steel balls 30 are provided thereon; in addition, a hollow portion 204 is provided in the center of the ring portion 201.

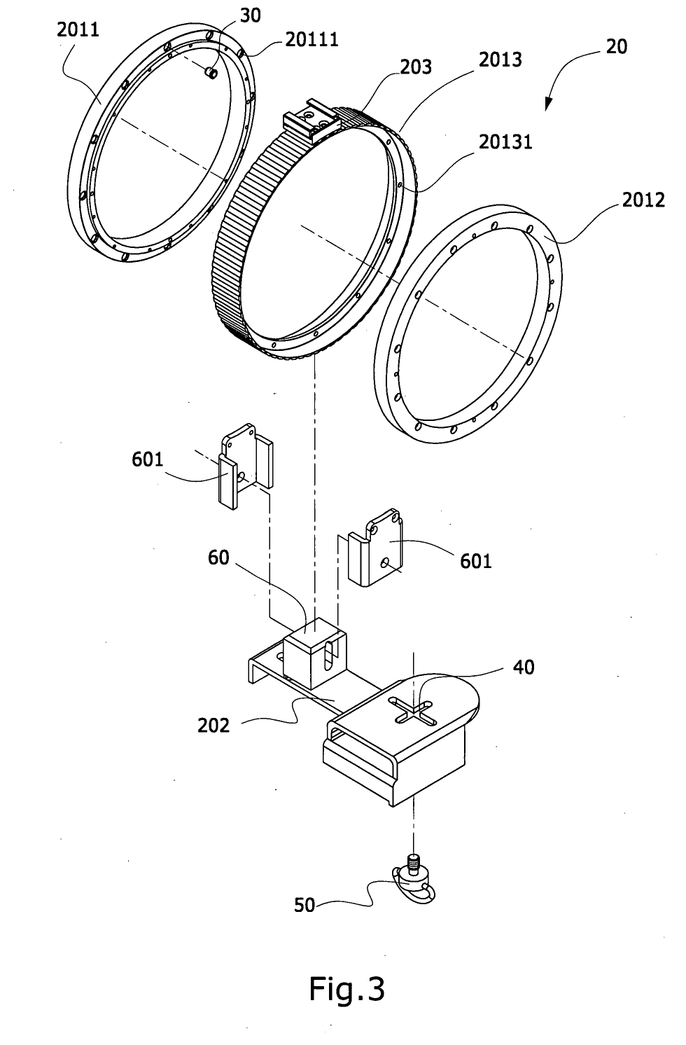

With reference to FIG. 3, the camera flash brackets 20 of the invention has the plate 202 thereof formed a 90 degree tilted ‘b’ shape, of which the higher position has a bayonet portion 40 provided thereon, a screw 50 is pierced through the bottom of the bayonet portion 40. A connection portion 60 is welded on the surface of the lower position of the plate, two barrier pieces 601 formed comparatively on the peripheral of the connection portion 60, enabling a space to be formed between the two barrier pieces 601, the space enables the ring portion 201 to be provided therein, comprising a first fastening ring 2011, a second fastening ring 2012 and a slip ring 2013. The first fastening ring 2011 and the second fastening ring 2012 are provided on the front and rear sides of the slip ring 2013, respectively; in addition, said first fastening ring 2011 has a plurality of groove 20111 formed on the inner surface thereof and the slip ring 2013 has a plurality of positioning holes 20131 formed thereon, wherein each of the grooves 20111 has one steel ball 30 positioned therein.

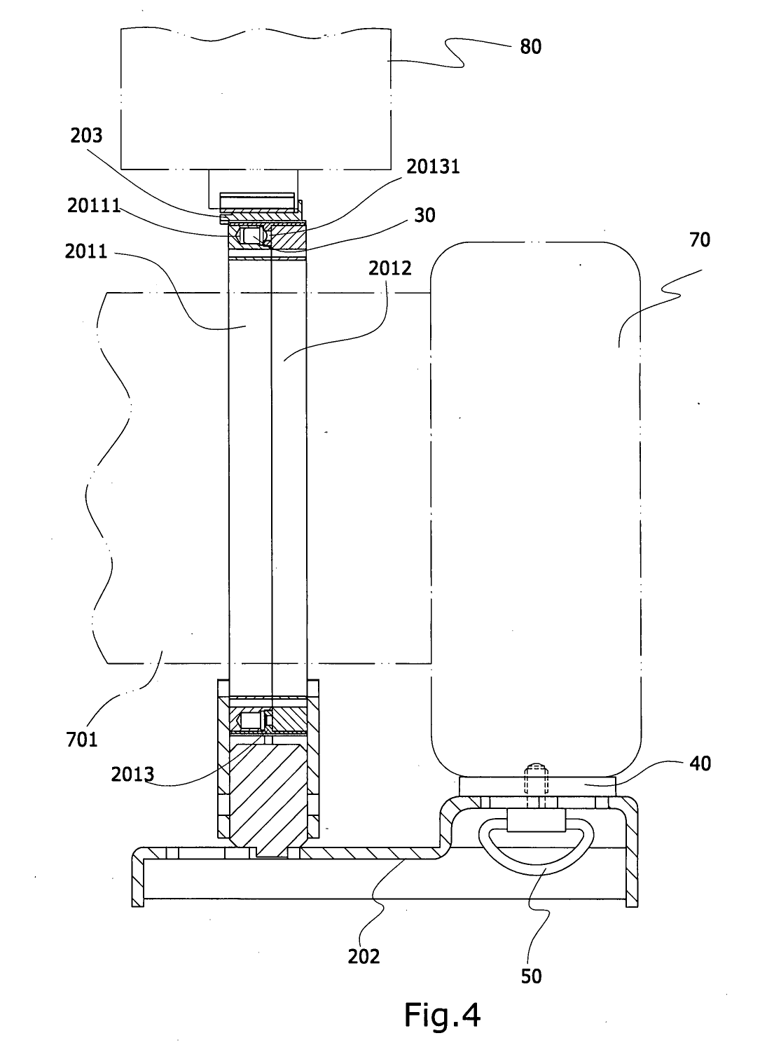

With reference to FIG. 4, an embodiment of the camera flash brackets of the invention, the camera flash brackets 20 can be applied to assembled with a camera 70, the bottom of the camera 70 enables a screw 50 to pierce through the surface of the bayonet portion 40 of the plate 202 and a lens 701 of the camera 70 is provided in the hollow portion 204 of the ring portion 201, in addition, the assembling portion 203 and a photoflash 80 are mounted together. When a user wants to adjust the position of the photoflash 80, s/he only needs to manually move the photoflash 80 to activate the rotation of slip ring 2012 of the ring portion 201, where the first fastening ring 2011 and the second fastening ring 2012 remain immovable status, in the meanwhile, each of the steel balls 30 in the positioning holes 20131 of the slip ring 2013 starts to roll out of the original positioning hole 20131 to the next positioning hole 20131 and fasten therein. Moreover, the assembling portion 203 is positioned on top of the slip ring 2013 to be assembled with the photoflash 80, therefore, when a user roll around the slip ring 2013, the position of the photoflash 80 can be jointly adjusted to the best position point for shooting.

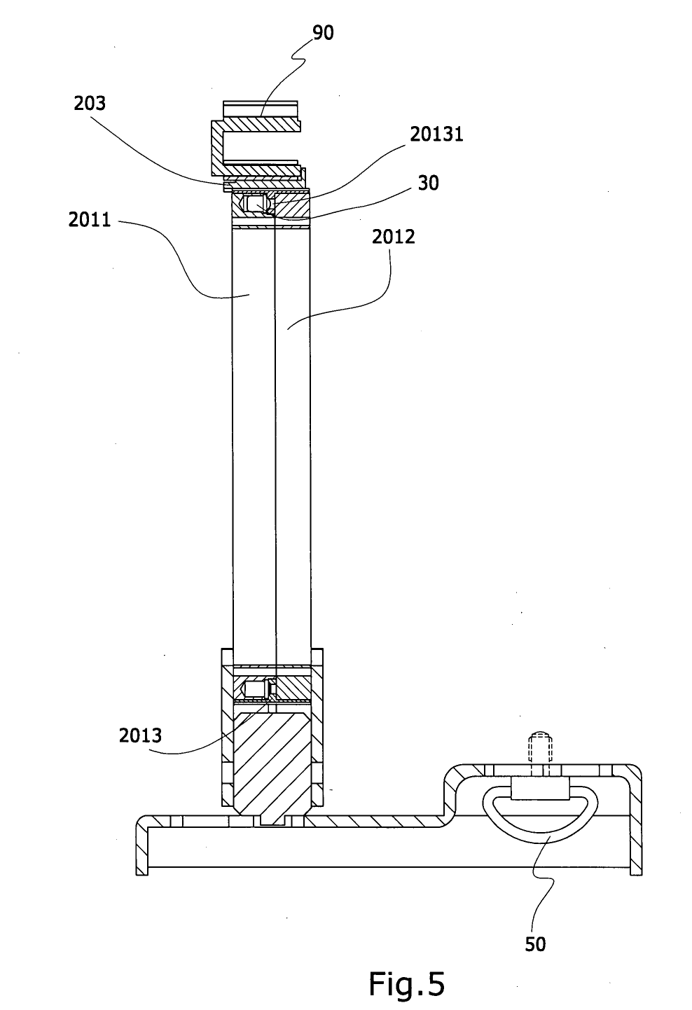

With reference to FIG. 5 showing a preferred embodiment (1) of the camera flash brackets of the invention, the assembling portion 203 of the camera flash brackets 20 is able to be assembled with one end of a pad 90 and the photoflash 80 is able to be assembled with the other end of the pad 90, so as to expand the lighting scope of the photoflash 80 and decrease the shadow in the shot.

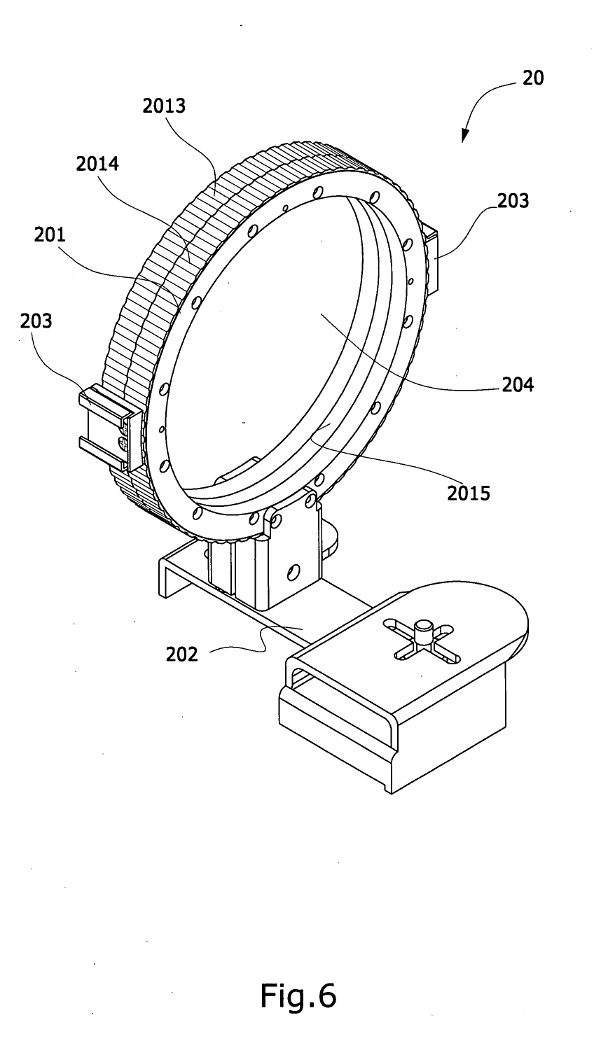

With reference to FIG. 6 showing another preferred embodiment (2) of the invention, the ring portion 201 of the camera flash brackets 20 comprises a plurality of slip rings, such as two slip rings 2013 and 2014 as shown in the figure; a third fastening ring 2015 is provided between the slip rings 2013 and 2014; said first fastening ring 2011 and the second fastening ring 2012 are provided on the lateral sides thereof, respectively; the respective external fringes of the slip ring 2013 and the slip ring 2014 have assembling portions 203 provided thereon each for a user to adjust the positions of the slip rings 2013 and 2014 of the photoflash 80 as required; by way of the first fastening ring 2011, the second fastening ring 2012 and the third fastening ring 2015 the slip rings 2013 and 2014 are able to be rolled around to enable a user to adjust a better lighting effect in the shot.

Moreover, the first fastening ring 2011 and the slip ring 2013 on the ring portion 201 of the camera flash brackets 20 are able to be replaced the steel balls 30 with gears for fastening purpose of changing the positions of the photoflash.

In view of the foregoing, the invention disclosed herein is a camera flash brackets that enables a photoflash to be quickly adjusted and positioned.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

To sum up, the camera flash brackets of the invention possesses the practicability and advancement in the field and is therefore disclosed therein.

What is claimed is:

1. A camera flash brackets, comprising:
a ring portion, comprising a slip ring, a first fastening ring and a second fastening ring; the first fastening ring and the second fastening ring are provided on the front and the rear side of the slip ring, respectively; the first fastening ring has a plurality of grooves set thereon, the slip ring has a plurality of positioning holes set thereon;
more than one steel balls, each of the steel balls is provided in each of the grooves;
an assembling portion, provided on top of the ring portion; and
a plate, having a connection portion provided on one end thereof, the connection portion and the ring portion are composed together, the other end of the plate has a bayonet portion set thereon.

2. The camera flash brackets of claim 1, wherein the plate is able to formed as a 90 degree tilted b shape.

3. The camera flash brackets of claim 1, wherein the plate has a plurality of connection portion provided thereon, each of the connection portion has a ring portion set thereon.

4. The camera flash brackets of claim 1, wherein the first fastening ring and the slip ring is able to form a gear module positioned in-between.
